(19) United States
(12) Patent Application Publication
(10) Pub. No.: US 2008/0001498 A1
(43) Pub. Date: Jan. 3, 2008

(54) Driving apparatus for a linear motion of elongated bodies

(76) Inventor: Fritz Muller, Ingelfingen (DE)

Correspondence Address: HENRY M FEIEREISEN, LLC, 350 FIFTH AVENUE, SUITE 4714, NEW YORK, NY, 10118, US

(21) Appl. No.: 11/458,127

(22) Filed: Jul. 18, 2006

(30) Foreign Application Priority Data
Jul. 18, 2005 (DE) 10 2005 033 455.5

(51) Int. Cl. H02N 2/04

(52) U.S. Cl. 310/317

(57) ABSTRACT

A driving apparatus for a linear movement of elongated bodies is provided with a holding device for holding the elongated body on its circumference during a rest state and/or during a motion state, and a moving device for initiating a movement of the elongated body in a direction of its longitudinal axis, with the holding device and the moving device each having piezoelectric elements.

The invention relates to a driving apparatus for a linear motion of elongated bodies, for example, valve tappets for different valves, such as seat valves, diaphragm valves and special valves, cylinders for operating devices or sliders.

Elongated bodies are conventionally operated mainly pneumatically. However, in the context of potential savings by eliminating pressure generating stations, there is a need for alternative driving apparatus concepts.

It is therefore an object of the invention to provide a driving apparatus for linearly moving elongated bodies, without necessitating pressure generating stations for this driving apparatus.

The object is solved in accordance with the invention by the driving apparatus set forth in claim 1. The dependent claims 2 to 12 recite particular embodiments of the driving apparatus according to claim 1.

The driving apparatus according to the invention is implemented, in particular, as a piezoelectric drive. It includes a holding device for holding the elongated body on its circumference during a rest state and/or during a motion state, and a moving device. The moving device causes a movement of the elongated body along its longitudinal axial direction. In particular, the holding device and the moving device include each piezoelectric elements.

According to a preferred exemplary embodiment, the holding device includes a first holding unit constructed in the form of clamping piezoelectric elements and located in a first plane for holding the elongated body on its circumference during a rest state and a second holding unit constructed in the form of clamping piezoelectric elements located in a second plane for holding the elongated body on its circumference during a motion state, with the first holding unit being provided in a receiving unit which is arranged about the elongated body in the axial direction and secured to the driving apparatus, and with the second holding unit being provided in a movable receiving unit which is arranged about the elongated body and extending along the axis of the elongated body, wherein the moving device designed as active piezoelectric elements is provided in a longitudinal direction on the circumference of the elongated body between the fixed receiving unit and the movable receiving unit and attached thereto in such a manner that the moving device can move along the axis of the elongated body when the active piezoelectric elements are activated.

Preferably, in a first driving phase only the first holding unit holds the elongated body; in a second driving phase both the first holding unit and the second holding unit hold the elongated body; in a third driving phase only the second holding unit holds the elongated body, while the moving device moves the elongated body across the movable receiving unit and the second holding unit; and in a fourth driving phase, after the elongated body has been moved, the second holding unit no longer holds the elongated body and only the first holding unit holds again the elongated body.

In particular, on each of the first and the second holding units there are provided at least two respective clamping piezoelectric elements, which are respectively secured radially inwards in the direction of the elongated body on the fixed receiving unit and the movable receiving unit, and respectively extend from the elongated body at a same angle in a plane. The clamping piezoelectric elements of the first holding unit and the clamping piezoelectric elements of the second holding unit are preferably arranged in relation to one another at an angular offset.

It is however also possible to provide at least two clamping piezoelectric elements on each of the first and the second holding unit, which are respectively arranged in parallel relationship on an intermediate element upon the fixed receiving unit and the movable receiving unit, with the intermediate element extending in a direction of the elongated body.

In particular, at least two active piezoelectric elements of the moving device are provided which extend in the longitudinal direction of the elongated body between the fixed receiving unit and the movable receiving unit.

According to a further preferred exemplary embodiment, the holding device and the moving device include a tooth system on the elongated body and individual teeth which are provided on respective piezoelectric elements and supported within a frame which is mounted to the driving apparatus and in which the elongated body extends. The teeth confronts the tooth system which has one less tooth than there are piezoelectric elements with teeth.

The teeth and the tooth system do not make contact in a rest position. In an initial position, a first tooth engages in an opposing tooth space in the tooth system, as it is extended out from the frame by the corresponding piezoelectric element, so that the elongated body is held. The teeth are further extended out by the associated piezoelectric elements sequentially out from the frame and moved into engagement with respective tooth spaces of the tooth system, so that the elongated body is moved as a result of the different number of teeth and those teeth of the tooth system and the resultant pitch difference between the teeth and the tooth system.

For decreasing the size of the adjustment intervals, several frames with piezoelectric elements and pertaining teeth may be arranged about the elongated body in such a manner as to be slightly offset along its longitudinal axis, whereby activation of piezoelectric elements causes teeth to engage with tooth spaces of the tooth system from frame to frame.

In particular, the driving apparatus also includes a control and switching unit for a desired activation and deactivation of the piezoelectric elements. The elongated body may be in particular a valve tappet for different valves, such as seat valves, diaphragm valves and special valves, a cylinder for operating a device or a slider.

Implementing the driving apparatus using piezoelectric elements not only obviates the need for pressure generating stations. Advantages can also be achieved with respect to motion speeds and, in the case of valve tappets, with respect to the shifting and closing speeds. The driving apparatus can be made relatively small. The elongated body can be very accurately positioned. In addition, retention and/or motion can be achieved without electric current flow, so that energy consumption can be reduced.

Further details, features and advantages of the invention are explained in the following detailed description of preferred embodiments with reference to the appended drawings. It is shown in:

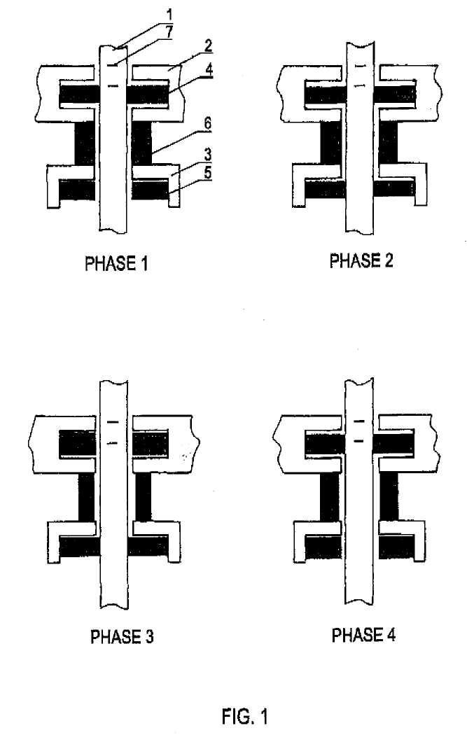

FIG. 1 a basic illustration of a driving apparatus according to a first preferred embodiment of the invention at different drive phases;

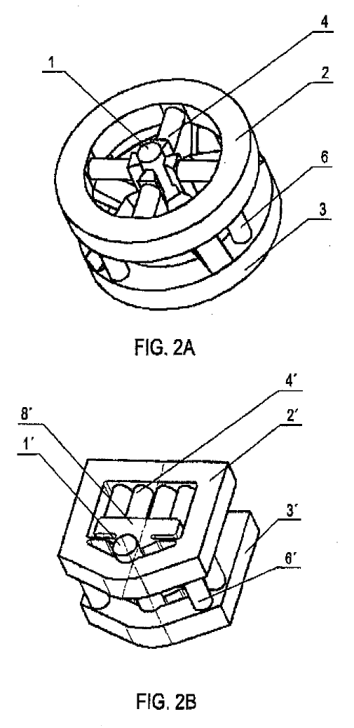

FIG. 2A a first implementation of the driving apparatus according to the first preferred embodiment of the invention;

FIG. 2B a second implementation of the driving apparatus according to the first preferred embodiment of the invention; and

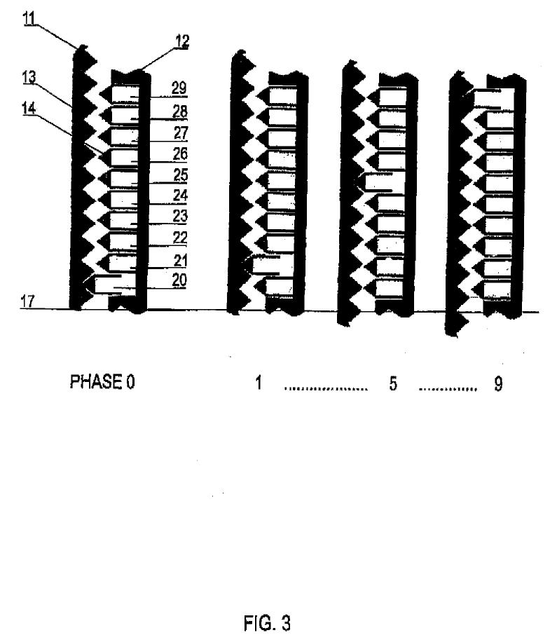

FIG. 3 a basic diagram of a driving apparatus according to second preferred embodiment of the invention at different drive phases.

Advantageous embodiments of the present invention will be described in more detail hereinafter with reference to the appended drawings.

FIG. 1 shows a basic illustration of a first preferred embodiment of the driving apparatus of the invention. The driving apparatus is illustrated as a linear piezoelectric stepper drive, wherein a receiving unit 2, which is attached to a housing (not shown) of the driving apparatus, is about an elongated body 1 in a first plane perpendicular to the elongated body 1, and a receiving unit 3, which is moveable with respect to the housing, is arranged in a second plane perpendicular to the elongated body 1. Respective holding units 4 and 5 implemented as clamping piezoelectric elements are provided in the receiving units 2 and 3. A moving device 6 in the form of an active piezoelectric element is provided in axial relation to the elongated body 1 and between the receiving units 2 and 3 and connected respectively thereto.

FIG. 1 shows different drive phases, PHASE 1 to PHASE 4, of the driving apparatus. In a first drive phase, PHASE 1, only the first holding unit 4 holds the elongated body 1; in a second drive phase, PHASE 2, both the first holding unit 4 and the second holding unit 5 hold the elongated body 1; in a third drive phase, PHASE 3, only the second holding unit 5 holds the elongated body 1, while the moving device 6 moves the elongated body 1 across the moveable receiving unit 3 and the second holding unit 5, and in a fourth drive phase, PHASE 4, the second holding unit 5 no longer holds the elongated body 1, following a movement of the elongated body 1, and again only the first holding unit 4 holds the elongated body 1. As shown in FIG. 1, the elongated body 1 moves in the direction toward the moveable receiving unit 3, as indicated in FIG. 1 by a marking 7 on the elongated body 1.

According to this first embodiment, the holding units 4 and 5 are clamping piezoelectric elements, whereby the clamping piezoelectric elements can reach their maximum length without current flow, thus obviating the need for a holding current. It is also possible that the clamping piezoelectric elements may also reach their minimum length without current flow, so that no current is required when the clamping piezoelectric elements do not retain the elongated body. The elongated body can be moved linearly in one or the other direction without a current by providing springs operating on the elongated body 1. This also reduces energy consumption.

The piezoelectric elements 4, 5, 6 provided according to FIG. 1 are preferably arranged as described hereinafter in more detail with reference to FIGS. 2A and 2B.

As shown in FIG. 2A, at least two clamping piezoelectric elements on each of the first holding unit 4 and the second holding unit 5 are arranged so that they are each secured on the fixed receiving unit 2 and the moveable receiving unit 3 in a radially inward direction of the elongated body 1 in a plane with the same angle. The clamping piezoelectric elements of the first holding unit 2 and the clamping piezoelectric elements of the second holding unit 3 are preferably arranged at an offset in relation to their angles.

As shown in FIG. 2B, at least two clamping piezoelectric elements of each of the first and the second holding unit 2′ and 3′ can be arranged parallel to each other in the direction of the elongated body 1′ on an intermediate piece 8′ on the fixed receiving unit 2′ and the moveable receiving unit 3′.

According to FIGS. 2A and 2B, at least two active piezoelectric elements of the moving device 6 or 6′ are arranged in such a way as to extend in the longitudinal direction of the elongated body 1 or 1′ between the fixed receiving unit 2 or 2′ and the moveable receiving unit 3 or 3′. This can enable a compact design of the driving apparatus.

The second preferred embodiment of the driving apparatus according to the present invention will now be described with reference to FIG. 3.

FIG. 3 shows a basic illustration of the driving apparatus according to the present invention, wherein an elongated body 11, of which only a (right) length side is shown, is provided with a tooth system 13. The elongated body 11 is disposed inside a frame 12 which is affixed on the driving apparatus. Provided in this frame 12 and secured on respective piezoelectric elements 20, 21, . . . , 29, which are attached to the frame 12, are single teeth 14 which oppose the tooth system 13 of the elongated body 11. he tooth system 13 has one less tooth than there are piezoelectric elements 20, 21, . . . , 29 with teeth 14. The holding device and the moving device of the invention therefore correspond to the tooth system 13 and the teeth 14 on the piezoelectric elements 20, 21, . . . , 29 of the driving apparatus depicted in FIG. 3.

FIG. 3 shows, by way of example, different drive phases, PHASE 0 to 9, of the driving apparatus. The teeth 14 and the tooth system 13 do not make contact in a rest position. In an initial position designated as PHASE 0, a first tooth 14 engages in an opposite tooth space of the tooth system 13 as it is extended out from the frame 12 by the corresponding piezoelectric element 20 so that the elongated body 11 is held. In further drive phases, the teeth 14 are sequentially extended out from the frame 12 by the respectively pertaining piezoelectric elements 21, . . . , 29 and placed in engagement with respective tooth spaces of the tooth system 13, so that the elongated body 11 performs a motion as a consequence of the different number of teeth 14 and teeth of the tooth system 13 and the resultant pitch difference between the teeth 14 and the tooth system 13. By way of example, the drive phases PHASE 1, PHASE 5, and PHASE 9 are depicted, with the marking 17 indicating that the elongated body 11 is moved by the associated piezoelectric element 20 in the direction toward the tooth 14.

To prevent the elongated body 11 from slipping inside the frame 12, at least one tooth 14 must be in engagement with a tooth space of the tooth system at any time. The tooth 14 should thus only be retracted during the drive phase when a next tooth 14 has almost completely engaged the tooth system 13.

There is no need to configure the teeth 14 as individual elements, as shown in FIG. 3, they can also be formed as a deformable toothed rack from which the respective tooth elements are moved by the piezoelectric elements 20, 21, 29 in the direction of the tooth system 13.

The adjustment intervals can be decreased by arranging several frames 12 with piezoelectric elements 20, 21, . . . , 29 and associated teeth 14 about the elongated body 11 in such a manner as to extend at a slight offset along its longitudinal axis, whereby the piezoelectric elements 20, 21, . . . , 29 are actuated to bring the teeth 14 into engagement with tooth spaces of the tooth system 13 from frame 12 to frame 12.

In this second preferred embodiment according to the present invention, movement and/or holding by means of a piezoelectric element can be realized without current flow. According to this second embodiment, high operating speeds and a high spatial resolution can be achieved

It is evident that both embodiments of the invention require a control and switching device for the desired activation and deactivation of the piezoelectric elements. The elongated body can be a valve tappet for different valves, such as seat valves, diaphragm valves and special valves, a cylinder for operating a device or a slider.

Because the driving apparatus according to the invention uses piezoelectric elements, pressure generating stations can be eliminated. It is also possible to achieve advantages with regard to motion speeds, i.e., adjustment and closing speeds when the elongated body is used as valve tappet. The driving device can be relatively small. In particular, the second embodiment enables very precise positioning. Holding and/or motion is possible without current flow. Power draw and energy consumption can thus be decreased.

With the present invention, a driving apparatus of simple design is provided, which allows precise and rapid movement and positioning of elongated bodies.

1-12. (canceled)

13. A driving apparatus for a linear movement of an elongated body, comprising:
a holding device for holding the elongated body on its circumference during a rest position or during a motion position; and
a moving device for initiating a motion of the elongated body in a direction longitudinally of its axis,
wherein the holding device and the moving device each comprise piezo elements.

14. The driving apparatus of claim 13, wherein the holding device includes a first holding unit which comprises clamping piezo elements disposed in a first plane for holding the elongated body in a rest state and a second holding unit which comprises clamping piezo elements disposed in a second plane for holding the elongated body in a motion state, wherein the first holding unit is disposed in a receiving unit which is arranged in the axial direction around the elongated body and attached to the driving apparatus, and wherein the second holding unit is disposed in a movable receiving unit arranged along the longitudinal axis of the elongated body and around the elongated body, wherein the moving device has active piezo elements which are attached on the circumference of the elongated body parallel to the longitudinal axis between the fixed receiving unit and the movable receiving unit, allowing the movable receiving unit to move along the longitudinal axis of the elongated body when the active piezo elements are activated.

15. The driving apparatus of claim 14, wherein in a first drive phase (PHASE 1) only the first holding unit holds the elongated body, wherein in a second drive phase (PHASE 2) both the first holding unit and the second holding unit hold the elongated body, wherein in a third drive phase (PHASE 3) only the second holding unit holds the elongated body, while the moving device moves of the elongated body across the movable receiving unit and the second holding unit, and wherein after the elongated body has moved, the second holding unit in a fourth drive phase (PHASE 4) no longer holds the elongated body, and only the first holding unit again holds the elongated body.

16. The driving apparatus of claim 14, wherein the first holding unit and the second holding unit each comprise at least two respective clamping piezo elements, which are each attached in a radially inward direction facing the elongated body on the fixed receiving device and on the movable receiving device, and which are each arranged in a plane with an identical angle relative to the elongated body.

17. The driving apparatus of claim 16, wherein the clamping piezo elements of the first holding unit and the clamping piezo elements of the second holding device are arranged with a mutual angular offset.

18. The driving apparatus of claim 14, further comprising an intermediate element extending parallel to the longitudinal axis, wherein the first holding unit and the second holding unit each comprise at least two respective clamping piezo elements arranged parallel to one another on the intermediate element disposed on the fixed receiving unit and the movable receiving unit.

19. The driving apparatus of claim 14, wherein the moving device comprises at least two active piezo elements which extend parallel to the longitudinal axis between the fixed receiving unit and the movable receiving unit.

20. The driving apparatus of claim 13, further comprising a frame attached to the driving apparatus and supporting the elongated body, wherein the holding device and the moving device comprise a gear tooth system formed on the elongated body and individual teeth which are each supported on a respective piezo element in the frame and face the gear tooth system, with a number of teeth on the gear tooth system being one less than a number of piezo elements that support the individual teeth.

21. The driving apparatus of claim 20, wherein the individual teeth and the gear tooth system do not make contact with each other in the rest position, wherein in an initial position (PHASE 0) a first piezo element moves a corresponding first individual tooth away from the frame and into engagement with an opposite tooth space in the gear tooth system, thereby retaining the elongated body, whereafter other piezo elements sequentially move corresponding individual teeth away from the frame and into engagement with respective other tooth spaces in the gear tooth system, whereby the different number of teeth of the gear tooth system and of the individual teeth representing a difference in pitch between the individual teeth and the gear tooth system causes the elongated body to move.

22. The driving apparatus of claim 20, further comprising a plurality of frames arranged about the elongated body with a slight offset along the longitudinal axis, each frame having piezo elements supporting individual teeth, wherein piezo elements disposed on different frames are activated to bring the individual teeth into engagement with tooth spaces of the gear tooth system for decreasing a size of adjustment intervals in the direction of the longitudinal axis.

23. The driving apparatus of claim 13, further comprising a control and switching unit for activating and deactivating the piezo elements.

24. The driving apparatus of claim 13, wherein the elongated body comprises a tappet for a valve.

25. The driving apparatus of claim 24, wherein the valve is selected from the group consisting of seat valves, membrane valves and special valves.

26. The driving apparatus of claim 13, wherein the elongated body comprises a cylinder for operating a device or a slider.
